(19) United States
(12) Patent Application Publication
(10) Pub. No.: US 2011/0074115 A1
(43) Pub. Date: Mar. 31, 2011

(54) Injection of sealant for pressure sealant type rotary seal

(75) Inventor: Roni Cohen Zada Vaizman, Beer Sheva (IL)

(73) Assignee: Tamar Technological Development Ltd, Omer (IL)

(21) Appl. No.: 12/587,025

(22) Filed: Sep. 30, 2009

(51) Int. Cl. F16J 15/18; F16J 15/16

(52) U.S. Cl. 277/513; 277/308

(57) ABSTRACT

An insert for a pressure sealant type sealing system, an improved sealing system for sealing between an aperture of a machine housing and a rotating shaft of the machine protruding through the aperture, comprising the insert to provide a pair of outlets into the driveshaft arranged collinearly around the driveshaft, a method of injecting the sealant into the stuffing box in two positions on opposite sides of the drive shaft thereby balancing the pressure, and a method of retrofitting existing pressure sealant systems by retrofitting with the insert.

### FIELD OF THE INVENTION

The present invention relates to the field of seals. More particularly, the invention relates to sealing systems for rotary shafts that include viscous sealants.

### BACKGROUND OF THE INVENTION

Many types of heavy rotary machinery, such as pumps, compressors and turbines, produce work by means of a working fluid enclosed within a working chamber or apply work to such a fluid. Such equipment is generally characterized by a main shaft that rotates with respect to a housing. Part of the shaft is coupled to the working fluid and part of the shaft protrudes from the housing.

At the aperture where the shaft exits the housing, there is a tendency for the working fluid to leak. To at least minimize, or better, to eliminate this leakage, the clearance between shaft and aperture perimeter is kept small and a seal is applied around the shaft and aperture. The seal is required to allow the shaft to rotate with minimal inhibition thereof, whilst blocking the space between the shaft and the aperture.

Numerous seal types are known. For low speed rotary machines, spring loaded gaskets, such as O-rings may be adequate. For high speed rotary machines, one common seal type is the mechanical seal which consists of radial planar surfaces normal to the shaft axis that are machined to low surface roughness. One surface is gasketed to the housing while a second surface is driven by the shaft and sealed thereon by a secondary seal such as a bellows. Mechanical seals of this type are generally expensive. They also have a tendency to fail catastrophically without warning. Furthermore, the repair of a faulty mechanical seal is costly and time consuming, since it generally necessitates extensive rotary machine downtime.

Another type of high speed rotary machine seal is the compression rope packing seal. This type of seal includes a braided rope that is wrapped around the shaft. Working fluid leaking from the housing keeps the rope moist and swells the fibers thereof. The working fluid prevents the rope from overheating and catching fire. Consequently, such seals cannot pump dry and their operation requires controlled leakage. The rope seals have a tendency to abrade the shaft surface, particularly during tightening and adjustment procedures. As the rope packing slowly loosens, it noticeably leaks, thereby provides early indication that maintenance is required, allowing the seal to be tightened. The rope packing material erodes relatively quickly due to friction and needs to be replaced often by time consuming replacement procedures.

To ensure tight fitting between the shaft and the solid seals, whether ‘O’ rings, rope seals, or other types of gaskets, the drive shaft must be cylindrical and accurately machined to a high surface finish. Pits and other irregularities result in leaking.

One leak-free sealing technique uses a viscous, non-Newtonian fluid that is injected into the stuffing box surrounding the drive shaft under pressure. Seals of this type are designed to prevent the working fluid from leaking from the working chamber through the space between the rotary shaft and the perimeter of the aperture through which the shaft exits the housing. The viscous sealant material may be bounded by one or more ‘O’ rings or rope seals at each end of the stuffing box, which serve to keep the sealant in place, and, because of their generally springy nature, tend to work with the fluid sealant to provide a leak-free seal.

By maintaining the pressure of the sealant within the stuffing box above the pressure of the working fluid in the working chamber, the sealant is pushed against the shaft, trapping the working fluid within the working chamber.

The stuffing box pressure is required to be sufficient to promote adhesion of the sealant onto the rotary shaft, and to retard leakage of working fluid from the working chamber into the stuffing box through the shaft aperture. The sealant pressure may generally be slightly less than the working fluid chamber due to the contribution of the surface tension of the sealant adhering to the shaft, which retards the infiltration of working fluid to the stuffing box. Leakage may be noticeable, however, if the pressure differential between the working chamber and stuffing box is greater than a threshold level such that the pressure-derived force acting on the shaft openings penetrates the sealant that adhered to the shaft.

As the sealant pressure is increased, the ‘lost work’, or work expended as a result of the frictional forces between the rotating shaft and the sealant correspondingly increases. This lost work is directly proportional to the product of the shaft diameter, rotational speed of the shaft, and the frictional forces between the shaft and the sealant that is adhered to the wall of the corresponding shaft opening. Since the frictional forces between the shaft and the sealant are directly proportional to the sealant pressure, it follows that the lost work is also directly proportional to the sealant pressure.

An increase in lost work is undesirable since the overall efficiency of the rotary machine decreases as more work is lost. Furthermore, the lost work is dissipated in the form of heat energy, which causes the temperature of the sealant in the vicinity of a shaft opening to increase. When the sealant temperature exceeds a recommended maximum temperature, a risk of sealant flammability exists, and additionally, the rate of heat transfer from the sealant to the working fluid is such that local boiling and cavitation within the working fluid is liable to result, particularly when the working fluid is water. Where the working fluid is a gas, an excessive increase in the working fluid pressure, which is liable to compromise the operability of the rotary machine, will result. Even though the lost work would decrease if the operating conditions of the rotary machine, such as working fluid pressure or shaft speed, were changed, such changes tend to further lower the overall machine efficiency since the operating conditions are generally selected to achieve optimal machine efficiency.

In general, therefore, as the pressure of the sealant within the stuffing box is increased, more work is required to turn the shaft and the efficiency of the system is adversely affected. However, the frictional forces between the rotating shaft and the surrounding sealant erode the adhered sealant, reducing the pressure of the sealant within the stuffing box, and if the pressure drops below the pressure of the working fluid, the working fluid will leak along the drive shaft. The optimal pressure at which the sealant is maintained is typically established empirically.

Such sealants are generally introduced into the stuffing box under pressure by an appropriate injection device through an aperture that can be sealed thereafter. Periodically, additional sealant needs to be introduced to the stuffing box to maintain the sealant pressure at a desired level. Generally the addition of such sealant and the operating pressure thereof are not optimal in that when the seal noticeably leaks, indicating too low a pressure, additional sealant is added, resulting in over-compensating generally resulting in too high a pressure. This issue is addressed in co-pending application number WO07099535A2 titled “Apparatus for delivering sealant at a predetermined pressure to a stuffing box of a shaft”. In the co-pending application, sealant pressure is maintained at a desired level by keeping a sealant injector coupled to the system at all times to inject fresh sealant as required to maintain a desired pressure.

It will be appreciated that typically, in addition to the desired rotation about their axes, drive shafts of real systems tend to vibrate as well. It has been found that such vibrations break the adhesion between the drive shaft and sealant, causing cavities to form along the drive shaft and resulting in leakage of the working fluid.

Where the injection of the sealant is opposite the drive shaft, it has been found to cause vibrations of the drive shaft. Also, the eccentric pressure onto the drive shaft has a tendency to cause the drive shaft distortion. The problem is most acute with non-constant injection systems but is also appreciable with constant pressure automatic injection systems.

One approach to overcoming the effects of sealant injection opposite the driveshaft is described in co-pending application number PCT/IL 2009/000128, where referring to FIG. 1 (corresponding to FIG. 13 thereof and retaining the annotations thereof) the sealant injector sleeve 56′ between the sealant injector 28 and the stuffing box 212′ is asymmetrically positioned rather than opposite the shaft 214. This was found to increase the effectiveness of the sealing system by minimizing vibration to the shaft 214 and aiding distribution of the sealant into the stuffing box 212′.

The present invention proposes an alternative solution that removes stress on the driveshaft and provides even better performance.

### SUMMARY OF THE INVENTION

The present invention is directed to providing an improved sealing system for sealing between an aperture of a machine housing and a rotating shaft of the machine protruding through the aperture, said sealing system comprising: (i) a stuffing box for encasing a segment of said shaft and the aperture of the machine housing; (ii) a viscous fluid type sealant within said stuffing box, and (iii) a sealant injector coupled to the stuffing box via (iv) a conduit system having an inlet for coupling to the sealant injector and a plurality of outlets arranged radially around the driveshaft to inject the sealant into the drive shaft in a plurality of positions around the drive shaft thereby balancing the pressure.

Preferably the plurality of outlets comprises a pair of outlets into the stuffing box arranged collinearly around the driveshaft to inject the sealant into the drive shaft in two positions on opposite sides of the drive shaft thereby balancing the pressure.

Preferably the inlet is arranged equidistantly to the two outlets.

Preferably the inlet and driveshaft are on a radius of the stuffing box that is perpendicular to diameter coupling the outlets and driveshaft.

Preferably the outlets direct the sealant into the stuffing box in a direction substantially perpendicular to the driveshaft.

Preferably the sealant is directed towards the aperture in the machine housing.

Preferably the improved sealing system comprises an insert to the stuffing box and the conduit system comprises a pair of conduits between said insert and said stuffing box.

In a second aspect, the present invention is directed to a method of reducing vibrations to a drive shaft of a sealing system by injecting sealant into the sealing system symmetrically at a plurality of positions around the driveshaft at a constant pressure at each position.

Preferably the plurality of injection positions includes two injection positions arranged on opposite sides of the driveshaft.

Preferably sealant injected into the stuffing box at the two injection positions is injected through outlets directed in a direction along the driveshaft.

Most preferably sealant injected through the two outlets is injected towards the aperture of the machine housing.

In a third aspect, the present invention is directed to an insert for insertion into a stuffing box of a pressure sealant type sealant system around a driveshaft, the insert for providing a conduit around the driveshaft. The conduit for providing a sealant passage coupling between an inlet for coupling to a sealant injector and a plurality of outlets arranged symmetrically about the driveshaft.

Preferably the plurality comprises two outlets.

Preferably the outlets are directed into the stuffing box in a direction along axis of the driveshaft.

Most preferably sealant injected at the two injection outlets is injected towards the aperture of the machine housing.

In a fourth embodiment, the present invention is directed to a method of improving a pressure sealant type sealant system having a sealant injector directed at the driveshaft comprising retrofitting an insert into a stuffing box of a pressure sealant type sealant system around a driveshaft, the insert for providing a conduit around the driveshaft between an inlet for coupling to a sealant injector and a plurality of outlets arranged symmetrically about the driveshaft.

As referred to herein, the term “shaft” relates to a rotary shaft.

As referred to herein, the term “stuffing box” refers to a cavity surrounding a segment of a shaft external to a machine housing, including an aperture to the machine housing, the stuffing box for providing a seal to the aperture to prevent leakage of working fluid.

Unless otherwise indicated by context, the term sealant as used herein refers to sealing materials that are high-viscosity non-Newtonian liquids, whose viscosity varies as a function of the shear stress applied thereto. Such sealants are generally fabricated from a blend of synthetic fibers, lubricants, and binding agents. U-PAK® injectable sealant manufactured by UTEX Industries, Inc. is an example of such a sealant.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1a is an elevation view of a sealing system of the PRIOR ART showing off-center injection of sealant;

FIG. 1b is a section through the PRIOR ART sealing system of FIG. 1a;

FIG. 2 is a cross-section through an injection system and stuffing box, showing an insert within the stuffing box;

FIG. 3 is an isometric projection of an insert in accordance with an embodiment of the invention;

FIG. 4 is a longitudinal section through a drive shaft and stuffing box through the injector inlet, and

FIG. 5 is longitudinal section through a drive shaft and stuffing box through the sealant outlets, perpendicular to the longitudinal section of FIG. 4.

### DESCRIPTION OF THE PREFERRED EMBODIMENTS

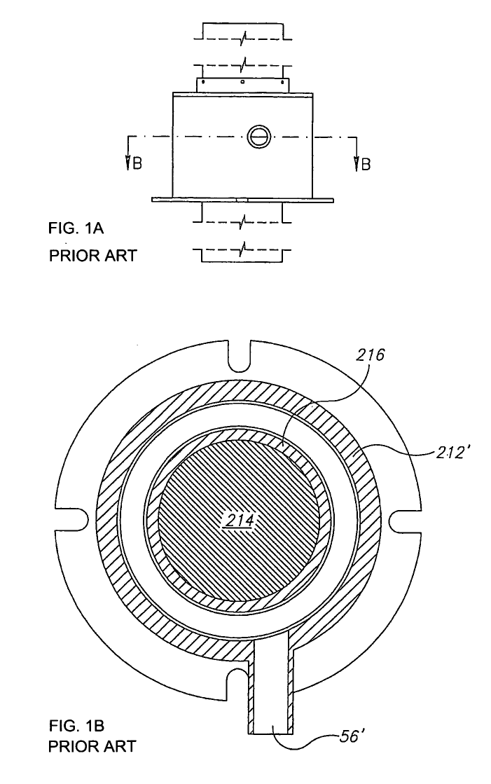

Referring to FIGS. 1a and 1b, in a prior art system as described in PCT/IL 2009/000128, the sealant injector sleeve 56′ that couples between the sealant injector (not shown) and the stuffing box 212′ is asymmetrical rather than opposite the shaft 214. This has surprisingly been found to increase the effectiveness of the sealing system by minimizing vibration to the shaft 214 and aiding distribution of the sealant into the stuffing box 212′.

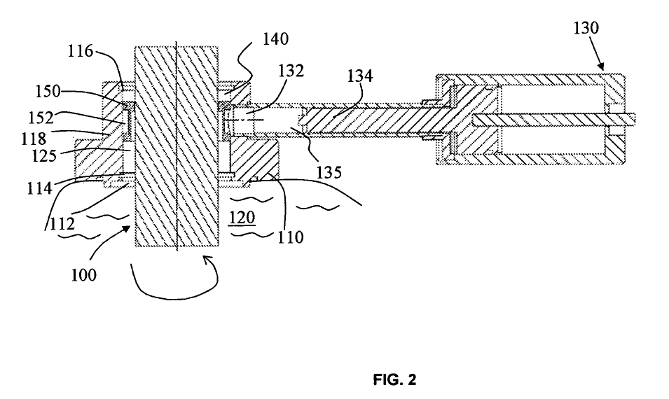

With reference to FIG. 2 a schematic cross section through a drive shaft 100 and stuffing box 110 is shown. Stuffing box 110 prevents leakage of working fluid 120 from a machine aperture. A sealant fluid 135, typically a high-viscosity non-Newtonian liquid, whose viscosity varies as a function of the shear stress applied thereto is injected into the stuffing box 110 via an injector 130 such as described as part 28 in PCT/IL2009/000128 incorporated herein by reference in its entirety. Essentially injector 130 includes a plunger 134 that squeezes sealant fluid 135 through inlet port 132 through wall 118 of stuffing box, into the cavity 125 of the stuffing box 110. The injector 130 is symmetrically mounted with respect to the drive shaft 100, i.e. radially extending outwards essentially perpendicular to the driveshaft 100. As explained in PCT/IL2009/000128 this configuration tends to apply stress to the driveshaft 100, causing vibrations and possibly warping thereof. In the present invention, an insert 150 is incorporated into the stuffing box, opposite the inlet port 132 of the injector 130. The insert 150 shields the driveshaft 100 from the pressure of the sealant injection and deflects the sealant from the driveshaft 100 around a conduit formed by the insert 150 and the wall 118 of the stuffing box 110. Parts 112, 114 and 116 are sealing rings, gaskets and the like. It will be appreciated that the insert 150 of the invention can be incorporated in a number of stuffing box configurations and used with various other sealing elements.

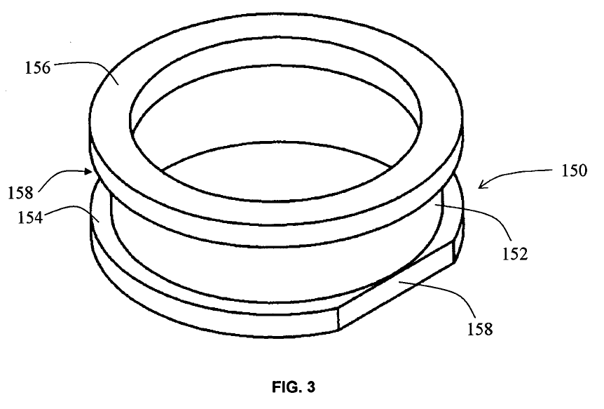

With reference to FIG. 3, a isometric projection of an insert in accordance with one embodiment of the invention is shown. A conduit 152 is formed around the insert between a proximal flange 154 and a distal flange 156. Proximal and distal flanges 154, 156 are dimensioned to fit the inner dimensions of the cavity 125 of the stuffing box, to come into close proximity with the wall 128 of the stuffing box 110. conduit 152 diverts sealant 135 from inlet port 132 in both directions around the insert 150. proximal flange 154 is provided with two regions 158 where the flange is truncated thereby providing sealant outlets from the conduit. (holes through the flange could serve the same purpose of course). When the insert 150 is placed into the cavity 125 of the stuffing box 110, the regions 150 serve as outlets ports for sealant 135, allowing it to ooze from the conduit 152 into the cavity 120 of the stuffing box 110. It will be noted the outlets are positioned on opposite sides of the insert 150 and thus inject sealant 135 on opposite sides of the drive shaft 110. Preferably the insert 150 is introduced into the stuffing box 110 proximal flange 154 towards the aperture of the machine, towards the working fluid 120. Preferably, the insert is positioned so that the outlets 158 are equidistant from the injection port 132, so that sealant pressure of sealant 135 entering the cavity 125 of the stuffing box 125 below the insert 150 is identical on both sides of the drive shaft 150. In this manner, direct pressure on the driveshaft 100 is relieved.

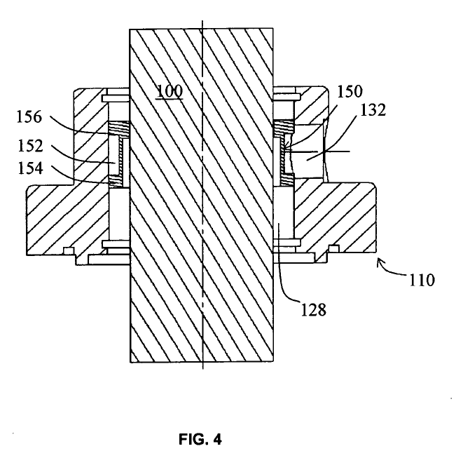

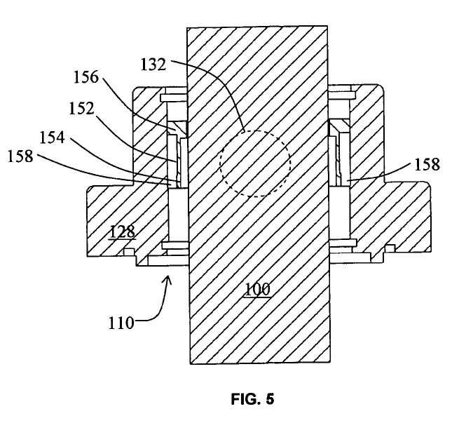

FIG. 4 is a longitudinal section through the stuffing box 110, drive shaft 100 and injector port 132 and injector 130, showing the insert 150 and cavity 152 therearound. FIG. 5 is a longitudinal section perpendicular to the section of FIG. 4, where the injection port 132 is perpendicular to the plain of the section, showing the sealant outlets 158 from the cavity 152.

As compared to previous proposed solution as shown in FIG. 1, the seal provided by the system of FIGS. 2, 4 and 5 has been found to have a number of advantages including the ability to hold a higher pressure of working fluid 120, reduced friction and thus less heat generated.

In the embodiment show, the pressure of the sealant 135 on the distal flange 156 is sufficient to keep the insert in position. It will be appreciated that the flange and the inside wall 128 of the stuffing box can also be machined to include holding means.

Apart from the asymmetrical injection system described with reference to FIG. 13 of PCT/IL 2009/000128, the aforementioned publication includes a number of innovations including inter alia crenellated drive-shafts, injector cartridges, internal water-cooling. Any and all the features described in PCT/IL 2009/000128 apart from FIG. 13 thereof are incorporated herein by reference and may be combined with the present invention.

The insert 150 may be configured in a number of ways to fit various stuffing boxes, and can be designed as part of an improved system or retrofitted into stuffing boxes using high-viscosity non-Newtonian liquids, whose viscosity varies as a function of the shear stress applied thereto. Such sealants are generally fabricated from a blend of synthetic fibers, lubricants, and binding agents. U-PAK® injectable sealant manufactured by UTEX Industries, Inc. Although the insert 150 of FIG. 3 is shown in FIG. 2, used with a constant pressure injector, it will be appreciated that the invention will improve performance of systems using intermittent injection as well.

Features shown with some specific embodiments may be incorporated with other embodiments. Thus the scope of the present invention is defined by the appended claims and includes both combinations and sub combinations of the various features described hereinabove as well as variations and modifications thereof, which would occur to persons skilled in the art upon reading the foregoing description.

Thus an insert, a sealing system incorporating the insert, a method of improving the efficiency of prior art sealing systems by incorporating the insert and a method of improved sealing of stiffing boxes is described.

In the claims, the word “comprise”, and variations thereof such as “comprises”, “comprising” and the like indicate that the components listed are included, but not generally to the exclusion of other components.

I claim:

1. An improved sealing system for sealing between an aperture of a machine housing and a rotating shaft of the machine protruding through the aperture, said sealing system comprising:
(i) a stuffing box for encasing a segment of said shaft and the aperture of the machine housing;
(ii) a viscous fluid type sealant within said stuffing box, wherein the shaft is concentric about its axis of rotation, and
(iii) a sealant injector coupled to the stuffing box via a conduit system having an inlet for coupling to the sealant injector and
(iv) a plurality of outlets into the driveshaft arranged radially symmetrically around the driveshaft to inject the sealant into the stuffing box in a plurality of positions around the drive shaft thereby balancing the pressure.

2. The system of claim 1 wherein said plurality of outlets comprises two outlets arranged collinearly on opposite sides of the driveshaft.

3. The system of claim 2 wherein the sealant inlet is arranged equidistantly to the two outlets.

4. The system of claim 3 wherein the inlet and driveshaft are on a radius of the stuffing box that is perpendicular to diameter coupling the outlets and driveshaft.

5. The system of claim 1 wherein the outlets direct the sealant into the stuffing box in a direction substantially perpendicular to the driveshaft.

6. The system of claim 1 wherein the improved sealing system comprises an insert to the stuffing box and the conduit system comprises a conduit between said insert and said stuffing box.

7. A method of reducing vibrations to a drive shaft of a sealing system by injecting sealant into the sealing system symmetrically at a plurality of positions around the driveshaft at a constant pressure at each position.

8. The method of claim 7 wherein the plurality of injection positions includes two injection positions arranged on opposite sides of the driveshaft.

9. The method of claim 8 wherein sealant injection at the two injection positions is through outlets directed in a direction along the driveshaft.

10. An insert for insertion into a stuffing box of a pressure sealant type sealant system around a driveshaft, the insert for providing a conduit around the driveshaft between an inlet for coupling to a sealant injector and a plurality of outlets arranged around symmetrically about the driveshaft.

11. The insert of claim 10 wherein said plurality of outlets comprises a pair of outlets.

12. The insert of claim 10 wherein the outlets are directed into the stuffing box in a direction along axis of the driveshaft.

13. A method of improving a pressure sealant type sealant system having a sealant injector directed at the driveshaft comprising retrofitting an insert as claimed in claim 10 into the stuffing box.
